(19) United States
(12) Patent Application Publication
(10) Pub. No.: US 2001/0019921 A1
(43) Pub. Date: Sep. 6, 2001

(54) Contact socket

(76) Inventor: Hans Jost Heimueller, Dudenhofen (DE)

Correspondence Address: Tyco Technology Resources, Suite 450, 4550 New Linden Hill Road, Wilmington, DE, 19808, US

(21) Appl. No.: 09/774,329

(22) Filed: Jan. 31, 2001

(30) Foreign Application Priority Data
Jan. 31, 2000 (EP) 00101875.3

(51) Int. Cl. H01R 13/434; H01R 13/187

(52) U.S. Cl. 439/745

(57) ABSTRACT

A contact socket according to the invention, which is formed in two parts, an engagement sleeve and a contact spring, the contact sleeve is engaged in a sleeve-like manner onto the frontal side of engagement sleeve where two-part construction allows the material for the engagement sleeve and the contact spring to be separate so the manufacturing process can be optimized and adapted to the individual component function.

### BACKGROUND OF THE INVENTION

The present invention relates to a contact socket having two-piece construction.

### DESCRIPTION OF THE PRIOR ART

The known contact sockets have a complicated construction and are therefore difficult to manufacture. These known contact sockets are expensive to manufacture.

### SUMMARY OF THE INVENTION

It is therefore an object of the present invention to provide a contact socket allowing the design of a simpler manufacturing process and which thereby entails lower costs.

This object is achieved by a contact socket having two parts, an engagement sleeve and a contact spring, the contact sleeve is engaged in a sleeve-like manner onto the frontal side of engagement sleeve where two-part construction allows the material for the engagement sleeve and the contact spring to be separate so the manufacturing process can be optimized and adapted to the individual component function.

Accordingly, the contact socket which is formed in two parts, comprises an engagement sleeve and a contact spring, which is slid in a sleeve-like manner onto the engagement sleeve and fixed thereto.

The two-part construction allows the material for the engagement sleeve 1 and the contact spring 2 to be separately provided and worked. The manufacturing process and materials can be optimized and adapted to the individual component.

Further advantageous developments of the contact socket according to the invention are the subject of the dependent claims.

### BRIEF DESCRIPTION OF THE DRAWINGS

FIG. 1 shows a schematic cross-sectional view of a contact socket according to the invention in accordance with a first preferred embodiment of the present invention;

FIG. 2 shows a further cross-sectional view of the contact socket according to FIG. 1;

FIG. 3 shows a layout of a contact spring of the contact socket according to FIGS. 1 and 2;

FIG. 4 shows a layout of an engagement sleeve of the contact socket according to FIGS. 1 and 2;

FIG. 5(a) shows a schematic cross-sectional view of a contact socket according to the invention, in accordance with a second preferred embodiment of the present invention; and (b) a top partial cross-sectional view.

FIG. 6 shows a further cross-sectional view of the contact socket according to FIG. 5;

FIG. 7 shows a layout of a contact spring of the contact socket according to FIGS. 5 and 6; and

FIG. 8 shows a layout of an engagement sleeve of the contact socket according to FIGS. 5 and 6.

### DETAILED DESCRIPTION OF THE PREFERRED EMBODIMENT

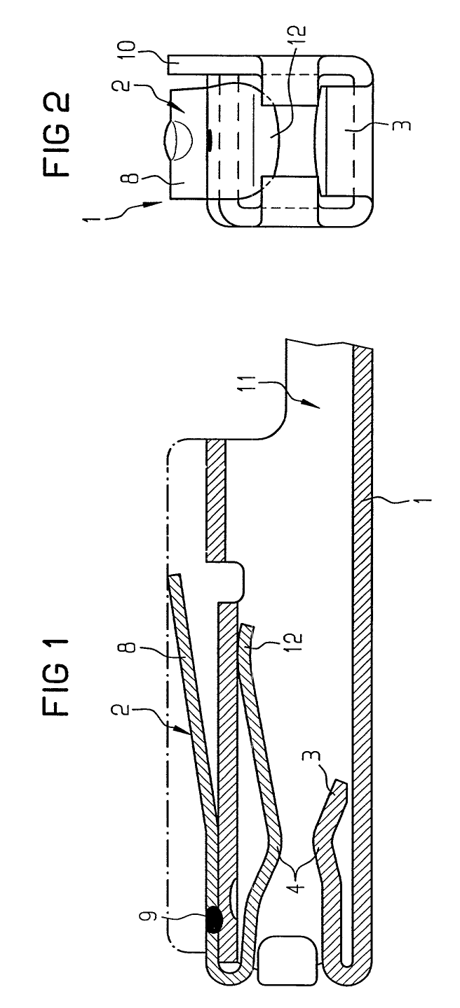

In FIGS. 1 and 2 there is shown, in accordance with a first embodiment, a contact socket according to the invention in a lateral cross-sectional view, the sleeve-like contact spring 2 which is slidingly engaged from the front onto engagement sleeve 1 and fixed thereto. On the other end of engagement sleeve 1, there is shown a terminal section 11 to which an electric conductor is crimped or soldered.

According to this first embodiment, a spring leg 12 is formed on one part on contact spring 2 and on the other part a latching tongue 8 is formed. The spring leg 12 lies inside the engagement sleeve 1. The latching tongue 8 lies outside of engagement sleeve 1. According to the view of FIG. 1, a counter spring 3 is located on the engagement sleeve 1 opposite spring leg 12, such that a contact location 4 between spring leg 12 and counter spring 3 is formed.

As can be seen from FIG. 2, the contact spring 2 is partially accommodated inside the engagement sleeve 1 whereby the latching tongue 8 protrudes upwardly at an acute angle of approximately 5°. The spring leg 12 forms a readily resilient contact metal piece by which current is directly, and therefore more efficiently, conducted.

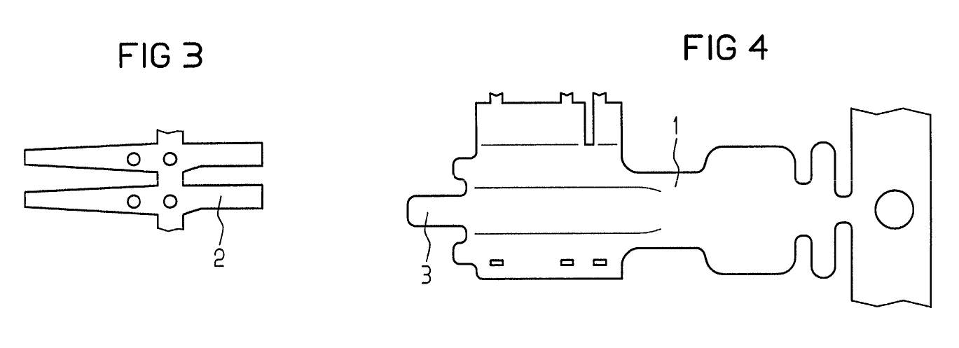

FIGS. 4 and 3 show the layout of the engagement sleeve 1 and of the contact spring 2. These representations are not to scale. The layout of contact spring 2 comprises a latching tongue 8 which, during forming of contact spring 2, while protruding outwardly, is bent upwards in order to allow attachment of the of the contact socket according to the invention in a receiving chamber (not shown) of a plug. In addition, a projection 10 is foreseen on the engagement sleeve 1 which is bent away from the engagement sleeve 1 approximately at a right angle, as is shown in FIG. 2, in order to form a polarisation of the contact socket.

The contours of the layouts of the engagement sleeves 1 and contact springs 2 are preferably stamped out of flat metal sheets as shown in FIGS. 3 and 4. After the stamping operation, the individual engagement sleeves 1 and contact springs 2 are separated and bent. The contact spring 2 and the engagement sleeve 1 are shaped by forming, whereafter contact spring 2 is slid from the front end onto engagement sleeve 1 and fixed thereto, until the state as shown in FIGS. 1 and 2 is established. The engagement sleeve 1 and the contact spring 2 are preferably laser soldered such that a solder pad 9 (from the top direction of the tool) is formed at least at one location.

The construction of the contact socket according to the invention, in particular through a cooperation of spring leg 12 and counter spring 3, allows the formation of the relatively readily resilient counter spring 3 whereby an improved spring action of the spring members can be achieved.

In the first embodiment described above the “flexibility” function is separate from the “current-conducting” function, as the contact spring 2 provides the flexibility and the counter spring 3 is responsible for the current conduction.

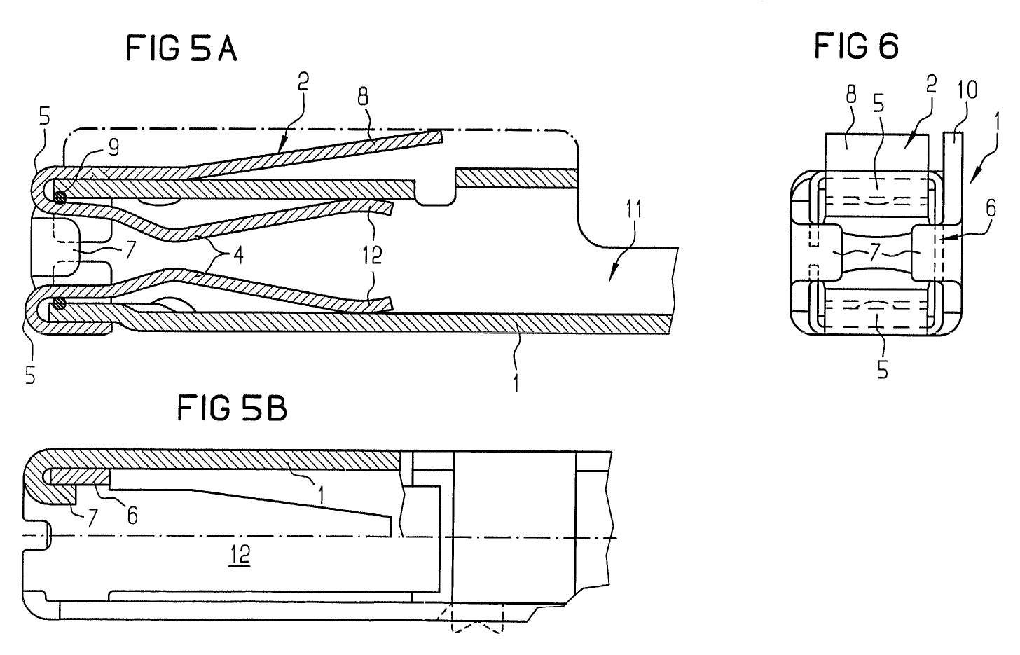

FIGS. 5 to 8 show a second embodiment of the present contact socket. The effect and function obtained correspond to the first embodiment. However, two springs legs 12 are formed on the contact spring 2, as can easily be seen from FIGS. 5 and 6. The advantage obtained thereby is that all spring functions are concentrated on one component, namely the contact spring 2.

FIGS. 5a, 5b and 6 show the contact socket according to the invention, in accordance with the second embodiment, whereby here, in a lateral cross-sectional view, there is shown the sleeve-like enclosure of engagement sleeve 1 by the contact spring 2 which is inserted from the front end. According to this second embodiment, two spring legs 12 are formed on contact spring 2 essentially facing each other. In FIG. 5a there is shown a mating section 5 which has an essentially U-shaped configuration and encompasses the front end of the engagement sleeve in sections.

FIG. 6 shows that on each side of the engagement sleeve 1 a tab 7 is positioned that also has a U-shaped configuration and which grips the sleeve sections 6 of contact spring 2, which lie in this region. The contact spring 2 is hereby secured to engagement sleeve 1. The contact spring 2 can be soldered to engagement sleeve 1 or fixedly secured thereto by means of a latching mechanism (not shown).

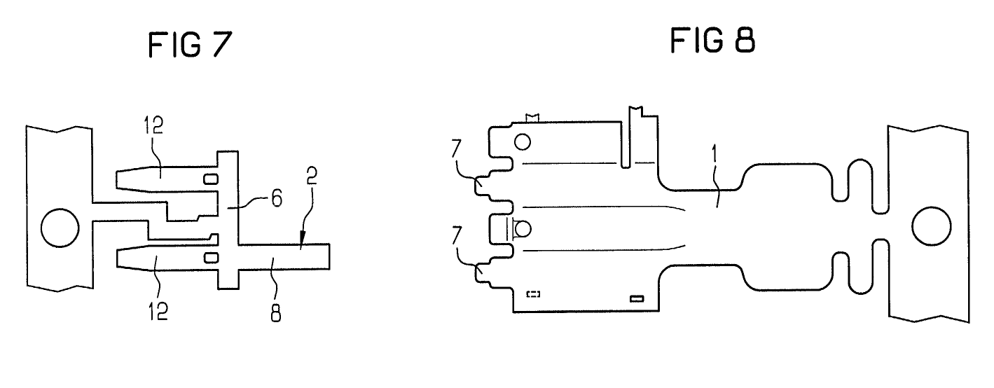

FIGS. 7 and 8 show the layout of the engagement sleeve 1 and the contact spring 2. These representations are also not to scale. The layout of the contact spring 2 comprises a latching tongue 8 which, during bending of the contact spring 2, while protruding outwardly is bent upwards in order to allow an anchorage of the contact socket in a receiving chamber (not shown) of a plug. In addition, a projection 10 is foreseen on the engagement sleeve 1 which is bent away from the engagement sleeve 1 approximately at a right angle, as is shown in FIG. 6, in order to form a polarisation of the contact socket

The contours of the layouts of the engagement sleeves 1 and contact springs 2 are preferably stamped out of flat metal, as shown in FIGS. 7 and 8. After the stamping operation, the individual engagement sleeves 1 and contact springs 2 are separated and bent. The contact spring 2 and the engagement sleeve 1 are first bent into shape whereafter the contact spring 2 is engaged onto engagement sleeve 1; finally, tabs 7 of engagement sleeve 1 are bent over until the state shown in FIGS. 5b and 6 is created. However, instead of tabs 7, an additional soldering operation can be foreseen on this section, if desired. The engagement sleeve 1 and the contact spring 2 are preferably laser soldered such that a solder pad 9 (from the top direction of the tool) is formed on several locations.

For the engagement sleeve, spring steel material, such as X12CrNi, is used, while for the contact spring, beryllium copper or steel provided with a precious metal plating is used.

In summary, the contact socket according to the invention is formed in two parts, an engagement sleeve 1 and a contact spring 2 which is engaged in a sleeve-like manner onto the frontal side of engagement sleeve 1. The two-part construction allows the material for the engagement sleeve 1 and the contact spring 2 to be separately provided and worked. The manufacturing process itself can be optimized and adapted to the individual component. The contact spring 2 is additionally provided with one or two spring legs 12 whereby, in the case of one spring leg 12, a counter spring 3 is formed on the engagement sleeve 1.

For further characteristics and advantages of the present invention, specific reference is hereby made to the appended claims and drawings.

I/we claim:

1. A contact socket comprising a contact spring and an engagement sleeve fixed thereto, the contact spring is slid onto the engagement sleeve and the contact spring comprises at least one spring leg.

2. The contact socket according to claim 1, characterised in that the contact spring comprises a latching tongue which is arranged outside of the engagement sleeve.

3. The contact socket according to claim 2, characterised in that contact spring is formed as an essentially U-shaped bent spring which is slid from the frontal side onto the engagement sleeve.

4. The contact socket according to claim 2, characterised in that contact spring is formed as an essentially U-shaped spring having two spring legs, whereby the contact spring is slid from the frontal side onto the engagement sleeve.

5. The contact socket according to claim 4, characterized in that the engagement sleeve is made of spring steel.

6. The contact socket according to claim 5, characterised in that the contact spring consists of beryllium copper.

7. The contact socket according to claim 6, characterized in that the contact spring is fixed to the engagement sleeve by means of at least one laser soldering operation.

8. The contact socket according to claim 7, characterised in that a counter spring is formed on the engagement sleeve opposite to the one spring leg.

9. The contact socket according to claim 7, characterised in that the contact spring comprises a sleeve section which is held by tabs formed on the lateral and the frontal side on the engagement sleeve.

10. The contact socket according to claim 9, characterised in that the engagement sleeve and/or the contact spring are each made from a flat metal sheet by stamping and bending.

11. The contact socket according to claims 10, characterised in that a polarisation is formed on the engagement sleeve in the form of a projection.
